(19) United States
(12) Patent Application Publication
(10) Pub. No.: US 2026/0004639 A1
(43) Pub. Date: Jan. 1, 2026

(54) SLOT GAME BLOCKCHAIN

(71) Applicant: IGT, Las Vegas, NV (US)

(72) Inventors: Stefan KEILWERT, St. Josef (AT); Soheil LATIFI, Brampton (CA); Michael RUSS, Graz (AT)

(73) Assignee: IGT, Las Vegas, NV (US)

(21) Appl. No.: 18/754,961

(22) Filed: Jun. 26, 2024

(51) Int. Cl. G07F 17/32; G06Q 20/36

(52) U.S. Cl. CPC G07F 17/3244; G06Q 20/367; G07F 17/326; G06Q 2220/00

(57) ABSTRACT

Methods, systems, and devices are provided herein. A gaming device includes a processor circuit and a memory coupled to the processor circuit. The memory includes machine-readable instructions that, when executed by the processor circuit, cause the processor circuit to perform operation including providing a blockchain that corresponds with an electronic gaming machine (EGM) at a given location. A player of the EGM is rewarded by providing a cryptographic token that corresponds to the EGM, and that returns value to the player based on other players redeeming benefits corresponding to the cryptographic token. The cryptographic token includes a token type that causes a modification in a payout mode that corresponds to a change in trigger probabilities. The cryptographic token is exchanged for currency during game play. Based on providing the player the cryptographic token, a token record is stored in the blockchain. The cryptographic token is bound to a player cryptowallet.

### BACKGROUND

Embodiments described herein relate to interactions with wagering games. Some wagering games, such as slot games and/or video poker games provided at Electronic Gaming Machines (EGMs) and/or mechanical gaming devices in a casino environment, may include unique game features as an additional incentive for play of a wagering game. Such unique game features for playing a wagering game other than merely playing a base game. For example, a user may interact with the wagering game by enabling a secondary wagering game in a gaming environment, such as in a casino environment, and related devices, systems, and methods. However, there is a need for providing additional options for extracting additional revenue from slot games.

### BRIEF SUMMARY

According to some embodiments, a system includes a processor circuit and a memory coupled to the processor circuit. The memory comprises machine readable instructions that, when executed by the processor circuit, cause the processor circuit to perform operations in the system. The processor circuit is operable to perform providing a blockchain that corresponds with a designated slot wagering asset. Operations include rewarding a player of the designated slot wagering asset by providing a cryptographic token that corresponds to the designated slot wagering asset. In some embodiments, the value may be return value to the player based on another player redeeming benefits corresponding to the cryptographic token. Some embodiments include, based on providing the player the cryptographic token that, a token record is caused to be stored in the blockchain. Some embodiments provide that the cryptographic token is bound to a player cryptowallet.

According to some embodiments, a system includes a processor circuit and a memory coupled to the processor circuit. The memory includes machine readable instructions that, when executed by the processor circuit, cause the processor circuit to perform operations in the system. The processor circuit is operable to perform operations described herein. For example, the processor circuit provides a blockchain that corresponds with an electronic gaming machine (EGM) at a given location. The processor circuit is further caused to reward a player of the EGM by providing a cryptographic token that corresponds to the EGM, and that returns value to the player based on other players redeeming benefits corresponding to the cryptographic token. Some embodiments provide that the cryptographic token includes a token type that causes a modification in a payout mode that corresponds to a change in trigger probabilities. In some embodiments, the cryptographic token is exchanged for currency during game play. The processor circuit is further caused to store, based on providing the player the cryptographic token, a token record in the blockchain. The processor circuit is further caused to bind the cryptographic token to a player cryptowallet.

According to some embodiments, a method includes operations of providing, by a processor circuit, a primary wagering game at a physical gaming asset to a player. Operations may include rewarding the player of the physical gaming asset by providing a cryptographic token that corresponds to the physical gaming asset and that returns value to the player based on other players redeeming benefits corresponding to the cryptographic token. In some embodiments, the cryptographic token includes a first cryptographic token that is associated with a first brand and a second cryptographic token is associated with a second brand that is different from the first brand. In some embodiments, the first cryptographic token is tradable with the second cryptographic token during game play. Operations may include providing a token eligibility definition that identifies a plurality of game play elements that the player completes to become eligible to receive the cryptographic token. Operations include storing, based on providing the player the cryptographic token, a token record in a blockchain in which the cryptographic token is bound to a player cryptowallet.

### BRIEF DESCRIPTION OF SEVERAL VIEWS OF THE DRAWINGS

FIG. 1 is a schematic block diagram illustrating a network configuration for a plurality of gaming devices according to some embodiments.

FIG. 2A is a perspective view of a gaming device that can be configured according to some embodiments.

FIG. 2B is a schematic block diagram illustrating an electronic configuration for a gaming device according to some embodiments.

FIG. 2C is a schematic block diagram that illustrates various functional modules of a gaming device according to some embodiments.

FIG. 2D is perspective view of a gaming device that can be configured according to some embodiments.

FIG. 2E is a perspective view of a gaming device according to further embodiments.

FIG. 3 is a schematic block diagram illustrating various operations for a blockchain token transaction according to some embodiments.

FIG. 4 is a schematic block diagram illustrating systems, apparatus and operations for creating a token ecosystem for slot games according to some embodiments.

FIG. 5 is a flowchart illustrating operations of systems/devices/methods for providing wagering game tokenization of a physical wagering asset according to some embodiments.

FIG. 6 is a flowchart illustrating operations of systems/devices/methods for providing wagering game tokenization of a physical wagering asset according to some embodiments.

FIG. 7 is a flowchart illustrating operations of systems/devices for providing wagering game tokenization of a physical wagering asset according to some embodiments.

### DETAILED DESCRIPTION

Embodiments herein include using blockchain technology to create a token-ecosystem for slot-games including, for example, land-based, online, and lottery, among others. Some embodiments provide that single games and/or families of games such as games that are in a link, may be linked to their own blockchain. Some embodiments provide that each game is enhanced with functionalities and unique tokens, that the player is rewarded with during play. Some of the tokens can be mystery, and may be achievement-based, and/or airdrops, among others.

In some embodiments, once a player receives a token, a record of the token may be taken in a blockchain that is associated with the game. The token may be bound to a player's account and/or wallet. Once the token is bound to the player's account and/or wallet, then that player is the owner of the token. In some embodiments, there may be multiple different types of tokens. For example, some token types may affect payout while other token types do not affect payout.

In some embodiments, tokens may include an individual value and/or may include additional value based on the quantity of tokens. In some embodiments, the value of a token may be based on the order in which the token was received relative to other received tokens. For example, token 1 may change background image of a game, token 2 may bonus trigger chances +1%, token 3 may bonus a trigger chance+1% as long as a player still owns tokens two and three and anytime during gameplay their bonus trigger chances are increase by 2%, and token 4 may have a bonus trigger chance+1% if player owns tokens two, three and four, the bonus. In some embodiments, the trigger chance may increase for an additional 0.5%. Such values, sequences and/or combinations are presented for example only and thus are non-limiting as other values, sequences and/or combinations are contemplated.

In some embodiments, standard slot games may be enhanced by using a blockchain based collection mechanism that may differentiate among products and that generates benefits for a player through collection tokens that can be redeemed to alter gameplay experiences, probabilities and payout.

In some embodiments, different types of coins may be differentiated. For example, a first type of token may include a cosmetic type that may provide changes in color, theme, timing and/or volume settings, among others. A second type of token may include payout relevant tokens that may change payout properties. For example, a relevant token may trigger different probabilities. In some embodiments, the payout relevant token may modify game rules. For example, a modification may provide that the game needs three symbols to trigger instead of four symbols. Some embodiments provide that additional bonus rounds may be enabled and/or activate jackpot levels may be activated.

In some embodiments, the player may be given the option to trade in any tokens they own at any time during gameplay. Some embodiments provide that an option for the player is to offer the token for sale on a dedicated platform. In some embodiments, the token may be monetized by allowing other players or users to buy it.

In some embodiments, a player may have the option to purchase tokens from other players on the trading platform, re-sell the token and/or make use of tokens during game play.

Some embodiments provide that in order to buy tokens on the trading platform, the player may be provided with the option to use credits from an in-game credit meter. In some embodiments, the player may buy manufacturer coins using FIAT currency and/or a cryptocurrency. Some embodiments provide that the player's wallet may be bound to the trading platform.

In some embodiments, the player may have the option to exchange any manufacturer coins into real money and/or crypto using the trading platform. For example, a player may receive a very unique, legendary item (token) during gameplay. If the player does not make use of the token then the player may offer it for sale to another person on the trading platform. In this example, the player may be able to sell the token to another person for 10,000 tokens that are associated with a given manufacturer. The player may then convert the 10,000 tokens into USD, after which the money may be transferred to their bank account. In some embodiments provide that the manufacturer may retain a fee that may be compensation for transfer and/or exchange fees.

In some embodiments, the token may be bound to anonymous player accounts. Some embodiments provide that anonymous players may redeem a player ID and load their existing tokens on the machine. In this manner, this arrangement may be useful to players who are concerned about privacy issues.

Some embodiments include setting up tokens for gambling prizes. In some embodiments, players with rare tokens can put them as gambling prizes. Some embodiments provide that the player may receive a share of the money gambled for the rare token until another player wins it. Once another player wins it, then the token value may transfer to a subsequent player.

In some embodiments, instead of providing the player the option to trade in any tokens they own at any time during gameplay, the game may have to be in a specific game state for the player to be allowed to use a token.

In some embodiments, a token might read “Grants additional 5 Free Spins in a bonus.” In such cases, the token may be activated by the player triggering the free spin bonus first.

Some embodiments provide that a token A can only become active if the player spends at least 100 credits per spin. In such embodiments, a token B might require the player to spend at least 500 credits per spin. The 100 credit and 500 credit values and are non-limiting as the credit limit requirements may be more or less than those provided above.

In some embodiments, the chances of winning a token may increase by owning more rare tokens. For example, in some embodiments, a game may start in “Low tier token mode” in which the player owns no tokens and has no crypto wallet connected to the game. As the game progresses, the player may trigger a “Standard token win”, which may correspond to a low tier token. In some embodiments, this may be the first token acquired by the player. In some embodiments, the player may be prompted to connect their wallet to the game in order to win the token.

Once the player has connected their wallet to the game, the game may be changed to “Medium tier token mode” in which the player, based on the fact that they already own a low tier token, may be eligible to win a medium tier token. Once the player owns a medium token, then the player may be eligible to turn the game into a “High tier token mode” where the player can finally win high tier tokens. As low tier tokens may be less rewarding than high tier tokens, the onboarding mechanism may be an onboarding mechanism that may increase a player's motivation to keep on playing for tokens since they may get more tokens the longer they play. Further, the player may receive benefits corresponding to the higher value tokens that they already own.

In some embodiments, a blockchain ledger may have a pre-defined achievements order. For example, the blockchain ledger may predefine that a first achievement is accomplished before a second achievement may be achieved and a second achievement is accomplished before a third achievement may be achieved. Some embodiments may include a plurality of first achievements and a plurality of second achievements. Accomplishing a first achievement may be performed by accomplishing any of the plurality of first achievements. Similarly, accomplishing a second achievement may be performed by accomplishing any of the plurality of second achievements.

In some embodiments, blockchains may be open-source. In such cases, anyone may be able to read data that is in the blockchains. For example, some embodiments provide that a blockchain may primarily be used for determining and/or preserving records of token wins. In some embodiments, previous wins may be written into the blockchain, permanently.

In some embodiments, upcoming tokens may be teased to a player. For example, a teaser message to a player may indicate an upcoming token win such as that the next block in the chain may include a token X and that the one after the next one may contain token Y. In that scenario, players may be teased about the upcoming wins and inspired to keep on playing because they are encouraged by the prospect of getting the next token.

Such embodiments may be used for single games in which the message is that the machine's next token reward will be an “X”. Some embodiments provide that one or more machines that are in a bank of games may be selected to earn a token. For example, a message may be that one machine in the bank configuration will next earn token X.

In some embodiments, a token progressive (e.g., local, wide-area and/or ultra-wide area) may be provided. In some embodiments provide that a huge number of machines are connected and one of the machines will trigger the next token reward X. Some embodiments provide that the same game across all token progressive-participating games may provide a token. In some embodiments, completely different and/or unrelated games may be played to earn a token and/or the same token progressive. Tokens may also be earned across different channels and/or channel type such as, for example, a land-based casino, online casino, and/or a video lottery terminal VLT, among others.

In some embodiments, different manufacturers may offer their own cryptocurrency that may be generated and/or sponsored by the associated manufacturer. In some embodiments, each of the manufacturers may include and/or provide their own ledger that may be connected to their corresponding gaming machines. In some environments, the manufacturer may only sponsor and/or transact in the cryptocurrency that corresponds to that manufacturer. In some embodiments, only the manufacturer's cryptocurrency may have transactions and stored on the associated ledger.

In some embodiments, tokens may be exclusively used by and or provided by a machine provided by the corresponding manufacturer. In some embodiments, coins and/or tokens might be limited to an originating blockchain and allow for now cross-chain-transactions so that a clear financial cut may be between the different manufacturers. Thus, also only specific manufacturer bonus tokens can be redeemed for that manufacturer's games.

In some embodiments, coins and/or tokens may be completely and flexibly purchased and/or traded. Thus, first manufacturer coins and/or tokens might compete with second manufacturer coins and/or tokens. In some embodiments, a token exchange may be provided that allows trading and price discovery among types of tokens. In this manner, values may fluctuate between the different coins and/or tokens.

In some embodiments, it might be cheaper by reducing transaction fees to use a first manufacturer coins to purchase a first manufacturer token.

Aside from manufacturer coins, there could also be operator coins which are redeemable across the entire casino floor, independent of who's machine it is.

Some embodiments provide that coins and/or tokens may be specific to a casino. In such embodiments, the casino may provide a crypto wallet in that casino for the casino specific assets.

In some embodiments, cryptographic tokens may be redeemable as game features or side games for a wagering game. For example, the game features may be accessed as part of a play session at a dedicated gaming device, e.g., an EGM, sports betting kiosk, etc., or may be accessed in an independent gaming environment, such as a mobile phone, tablet, or other player device.

In some embodiments, cryptographic token-based game content can be provided in a flexible and cost-effective manner. In some embodiments, blockchain technology may be used to tokenize one or more wagering games. For example, any or all of a slot game, slot game themes, slot machine cabinets, and/or groups of games, cabinets and/or combination thereof may be tokenized. Some embodiments provide that the wagering games may further include online, land-based and/or lottery games, among others.

As provided above, a wagering game, such as a slot game, may be split into a defined number of tokens. For example, the wagering game may be split into 1000 tokens. In some embodiments, each token may represent an ownership share of the wagering game. In some embodiments, the tokens may be purchased by a player, a spectator, an interested party, and/or a legal entity, among others. Based on ownership of the token, revenue may be created for the token owner. Additionally, the revenue received from selling the token may be revenue for the wagering game owner.

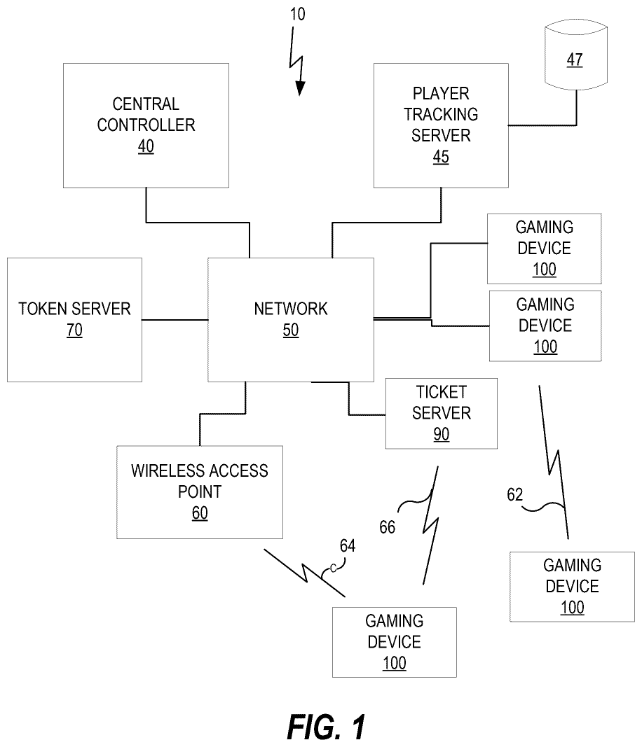

Before describing these and other features in greater detail, reference is now made to FIG. 1, which illustrates a gaming system 10 including a plurality of gaming devices 100. The gaming devices 100 may be one type of a variety of different types of gaming devices, such as electronic gaming machines (EGMs), mobile gaming devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. The central controller 40 may be any suitable server or computing device which includes at least one processing circuit and at least one memory or storage device. Each gaming device 100 may include a processing circuit that transmits and receives events, messages, commands or any other suitable data or signal between the gaming device 100 and the central controller 40. The gaming device processing circuit is operable to execute such communicated events, messages or commands in conjunction with the operation of the gaming device 100. Moreover, the processing circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processing circuits. Moreover, in some embodiments, one or more of the functions of one or more gaming device processing circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processing circuit that transmits and receives events, messages, commands or any other suitable data or signal between the ticket server 90 and the central controller 40. The ticket server 90 processing circuit may be operable to execute such communicated events, messages or commands in conjunction with the operation of the ticket server 90. Moreover, in some embodiments, one or more of the functions of one or more ticket server 90 processing circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, a near field communications (NFC) link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

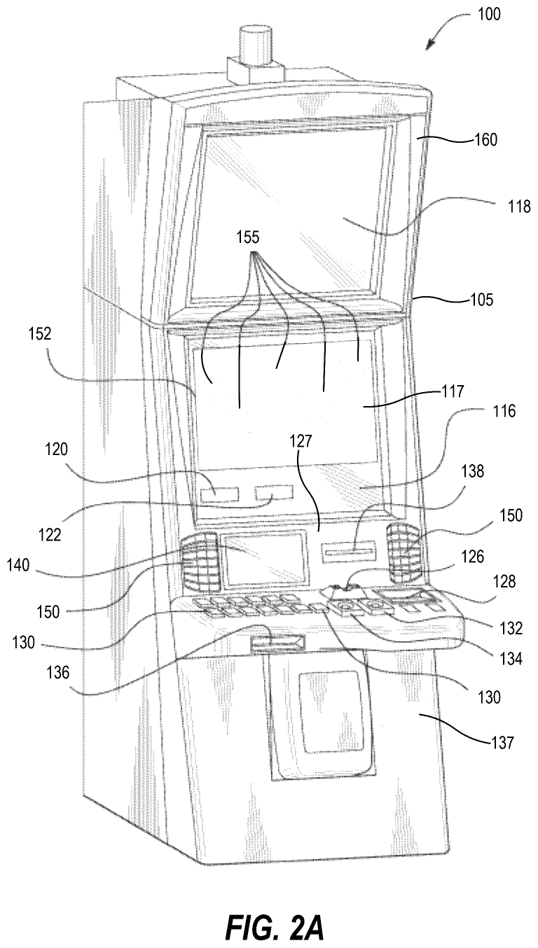

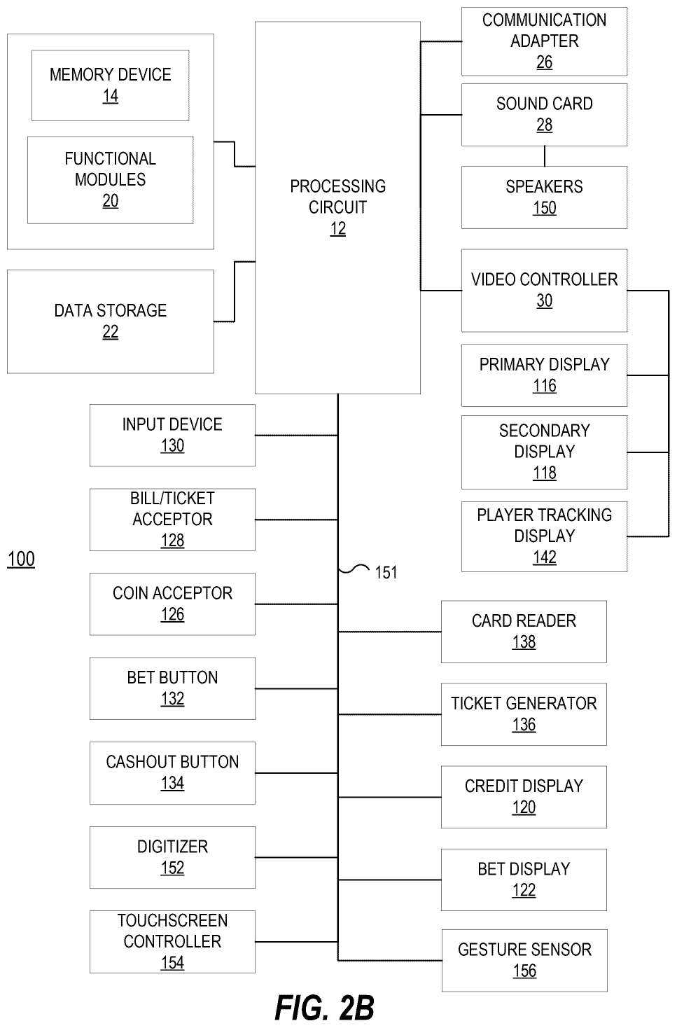

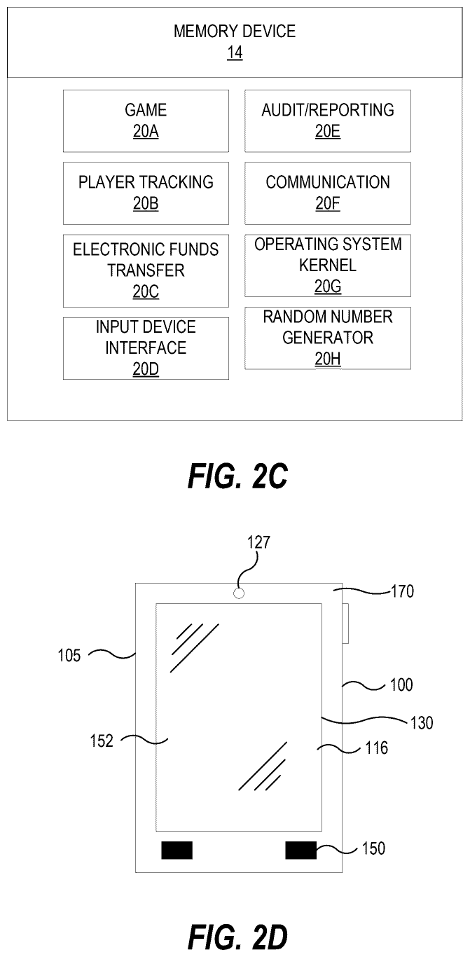

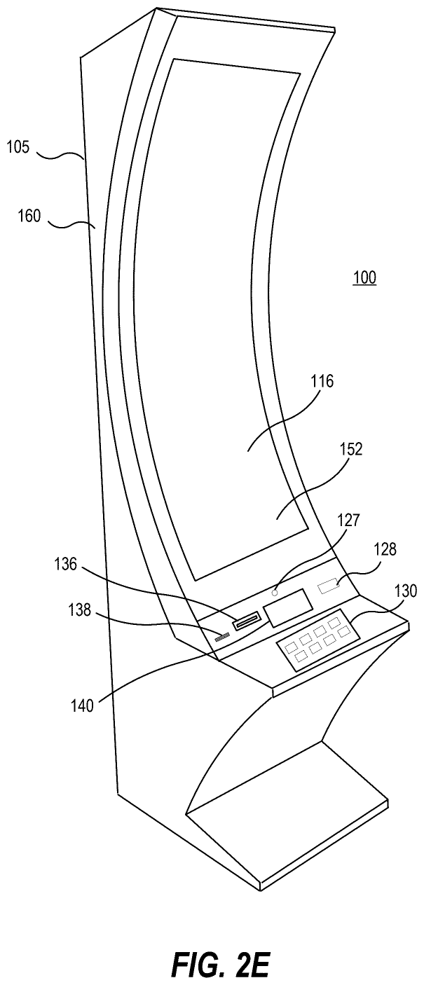

Embodiments herein may include different types of gaming devices. One example of a gaming device includes a gaming device 100 that can use gesture and/or touch-based inputs according to various embodiments is illustrated in FIGS. 2A, 2B, and 2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A to 2C are provided as examples for illustrative purposes only. It will be appreciated that gaming devices may come in many different shapes, sizes, layouts, form factors, and configurations, and with varying numbers and types of input and output devices, and that embodiments are not limited to the particular gaming device structures described herein.

Gaming devices 100 typically include a number of standard features, many of which are illustrated in FIGS. 2A and 2B. For example, referring to FIG. 2A, a gaming device 100 (which is an EGM 160 in this embodiment) may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously-placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as gesture sensors 156 for gesture input devices, and/or a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processing circuit 12 or directly from a memory device 14 and displays the video data on the display screen. The credit display 120 and the bet display 122 are typically implemented as simple liquid crystal display (LCD) or light emitting diode (LED) displays that display a number of credits available for wagering and a number of credits being wagered on a particular game. Accordingly, the credit display 120 and the bet display 122 may be driven directly by the processing circuit 12. In some embodiments however, the credit display 120 and/or the bet display 122 may be driven by the video controller 30.

Referring again to FIG. 2A, the display devices 116, 118, 140 may include, without limitation: a cathode ray tube, a plasma display, an LCD, a display based on LEDs, a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touch-screen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

In some embodiments, a display device may display symbols that, in some embodiments, may be referred to as icons on the display device. In some embodiments, the placement, movement and/or location of the icons may be determined based on computational efficiency corresponding to the gaming device and/or display device.

In some embodiments, the gaming system 10 includes a token server controller 70. The token server 70 may be a computing system that communicates through the data communication network 50 with the ticket server 90 and the AR device 200 and/or VR device 201 to coordinate the tokenization of a physical wagering machine into cryptographic tokens that each represent an ownership share of a revenue stream of the physical wagering machine. The token server 70 may be implemented within or separately from the central controller 40.

In some embodiments, the token server 70 may coordinate the buying, selling and/or trading of cryptographic tokens that correspond to physical wagering games. In some embodiments, the tokenization controller may include a blockchain that is operable to receive, transmit and/or store data corresponding to the cryptographic tokens. Some embodiments provide that the blockchain is external to the token server 70 and communicates with the blockchain to maintain data corresponding to cryptographic tokens therein.

Moreover, in some embodiments, the token server 70 may coordinate one or more releases of sets of cryptographic tokens that may include the same terms as previous releases and/or may include tokens having different rights and/or terms.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket dispenser 136, a bill/ticket acceptor 128, and a coin acceptor 126 that allows the player to deposit coins into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processing circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processing circuit 12 that controls operations of the gaming device 100. Although illustrated as a single processing circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processing circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processing circuit 12. It will be appreciated that the components may be connected to the processing circuit 12 through a system bus 151, a communication bus and controller, such as a universal serial bus (USB) controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processing circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, Digital Video Disc (“DVD”) or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or NFC that enable the gaming device 100 to communicate, for example, with a mobile communication device operated by a player.

The gaming device 100 may include one or more internal or external communication ports that enable the processing circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, Small Computer System Interface (“SCSI”) ports, solenoids, speakers, thumb drives, ticket readers, touch screens, trackballs, touchpads, wheels, and wireless communication devices. In some embodiments, internal or external peripheral devices may communicate with the processing circuit through a USB hub (not shown) connected to the processing circuit 12.

In some embodiments, the gaming device 100 may include a sensor, such as a camera 127, in communication with the processing circuit 12 (and possibly controlled by the processing circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processing circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

In some embodiments, a gaming device 100 includes a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

For example, referring to FIG. 2D, a gaming device 100 (which is a mobile gaming device 170 in this embodiment) may be implemented as a handheld device including a compact housing 105 on which is mounted a touchscreen display device 116 including a digitizer 152. One or more input devices 130 may be included for providing functionality of for embodiments described herein. A camera 127 may be provided in a front face of the housing 105. The housing 105 may include one or more speakers 150. In the gaming device 100, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100 may omit certain features, such as a bill acceptor, a ticket generator, a coin acceptor or dispenser, a card reader, secondary displays, a bet display, a credit display, etc. Credits can be deposited in or transferred from the gaming device 100 electronically.

FIG. 2E illustrates a standalone gaming device 100 (which is an EGM 160 in this embodiment) having a different form factor from the EGM 160 illustrated in FIG. 2A. In particular, the gaming device 100 is characterized by having a large, high aspect ratio, curved primary display device 116 provided in the housing 105, with no secondary display device. The primary display device 116 may include a digitizer 152 to allow touchscreen interaction with the primary display device 116. The gaming device 100 may further include a player tracking display 142, an input device 130, a bill/ticket acceptor 128, a card reader 138, and a bill/ticket dispenser 136. The gaming device 100 may further include one or more cameras 127 to enable facial recognition and/or motion tracking.

Although illustrated as certain gaming devices, such as electronic gaming machines (EGMs) and mobile gaming devices, functions and/or operations as described herein may also include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

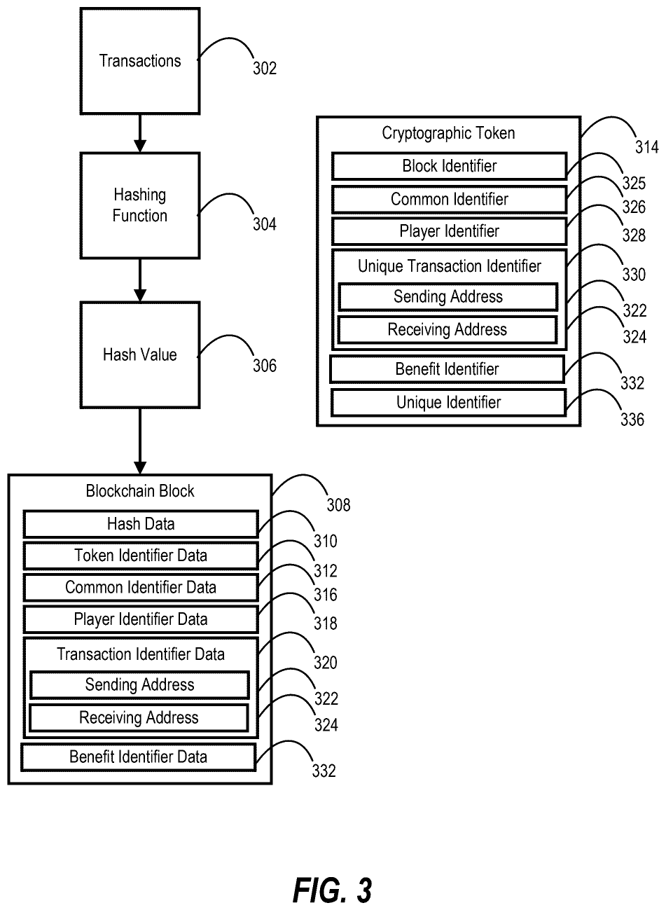

Referring now to FIG. 3, a schematic block diagram illustrates various operations for a blockchain transaction recordation according to some embodiments. As illustrated in FIG. 3, transactions 302 may occur at various blockchain nodes. In accordance with various embodiments, a hash may be created for each entry. For example, a cryptographic hash function may create a one-way, (essentially) collision free signature of the entry. The hash algorithm generates a hash. Using hashing function 304, hash values 306 of these transactions are created and added to blockchain blocks 308 that are in the blockchain data structure.

In this example, each blockchain block 308 may include one or more different types of data. For example, each blockchain block 308 may include cryptographic hash data 310 indicative of a result of the hashing function 304 associated with a common blockchain, token identifier data 312 indicative of an identity of a cryptographic token 314 associated with the block 308, common identifier data 316 indicative of the cryptographic token 314 being part of a plurality of cryptographic tokens, e.g., a defined subset of tokens based on different criteria, associated with the common blockchain, player identifier data 318 indicative of an identity of a player associated with the cryptographic token 314, transaction identifier data 320 associated with the unique transaction on the blockchain, which may include a sending address 322 associated with a provider of the cryptographic token 314 and a receiving address 324 associated with the player identifier data 318.

The cryptographic token 314 may include some or all of the data structure of the respective associated block 308 and/or may contain a block identifier 325 referring to the associated block 308, which allows the cryptographic token 314 to be securely and transparently authenticated against the blockchain. In some examples, the cryptographic token 314 may include a common identifier 326 corresponding to the common identifier data 316 and indicative of the cryptographic token 314 being part of the plurality of cryptographic tokens, and a player identifier 328 corresponding to the player identifier data 318 and indicative of a player associated with the cryptographic token 314. The cryptographic token 314 may include a unique transaction identifier 330 associated with a unique transaction on the blockchain, i.e., a unique block 308, and may include the sending address 322 and/or the receiving address 324.

For example, a new transaction for the cryptographic token may include transmitting a transaction indication of the new transaction including a sending address 322 and receiving address 324, and, based on the transaction indication, modifying the player identifier data 318 in a new block 308 and/or the player identifier 328 of the cryptographic token 314 to be indicative of a different player.

In some examples, each block 308 may further include benefit identifier data 332 associated with a game benefit being provided to the player associated with the cryptographic token 314. Alternatively, or in addition, the cryptographic token 314 may include a benefit identifier 334 corresponding to the benefit and/or benefit identifier data 332. Each cryptographic token 314 may be a fungible token that is fungible with other cryptographic tokens, and/or may further include a unique identifier 336, which may correspond to the token identifier data 312 of the block 308, such that the cryptographic token 314 is a non-fungible token that is not fungible with other cryptographic tokens.

As a general principle, a validation process may be performed to ensure that each new blockchain block 308 meets the criteria for inclusion into the blockchain data structure. In a blockchain configuration, there are varying consensus algorithms that can be used. For example, a private blockchain may choose an algorithm such as Practical Byzantine Fault Tolerance (PBFT). The PBFT mechanism may be useful for small networks, such as networks having fewer than about 100 nodes. Other examples include a Proof of Work (PoW) consensus algorithm and/or a Proof of Stake (POS) consensus algorithm, which may be used as the value of an underlying data block and/or value changes.

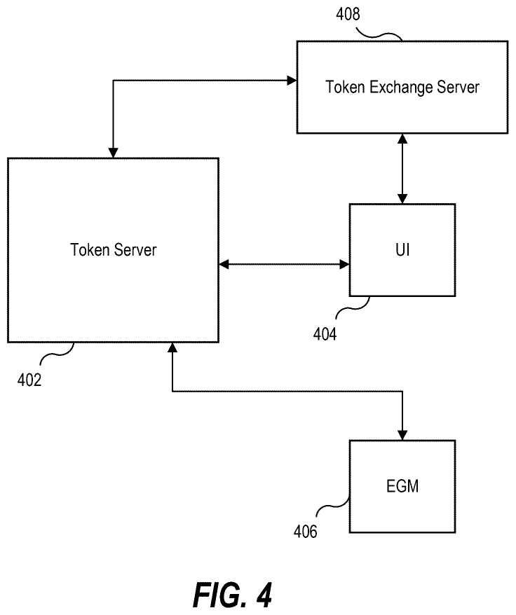

Reference is now made to FIG. 4, which is a schematic block diagram illustrating systems, apparatus and operations for creating a token ecosystem for slot games according to some embodiments. Some embodiments include a token server 402 that is operable to mint one or more pools of tokens. The tokens can be awarded to a player of a slot machine based on performance of defined tasks and/or transactions to acquire the tokens corresponding to the slot machine. In some embodiments, the pools of tokens may include different types of tokens that provide different values. In some embodiments, the EGM 406 may include any type of physical wagering devices and/or groups of physical wagering devices. In some embodiments, the cryptographic tokens may each represent an ownership share of one or more tokens corresponding to the slot games. In some embodiments, the token server 402 includes and/or is in communication with a blockchain that is operable to manage the ownership of the cryptographic tokens.

In some embodiments, a token exchange server 408 that may determine token transaction parameters corresponding to buy, sell, trade, and/or earned transactions. In some embodiments, the token exchange server 408 may also determine a per token value for buying, selling and/or trading the cryptographic token.

A user interface (UI) 404 is operable to receive inputs from the token server 402. For example, data flow between the token server 402 and the UI 404 may be associated with transactions corresponding to the cryptographic token purchases, sales and trades, among others. The UI 404 may be operable to exchange data with the token exchange server 408. For example, the UI 404 may provide information regarding the disposition of revenue generated based on input received by a player via the UI 404. In some embodiments, the token award may be based on the math corresponding to the EGM 406.

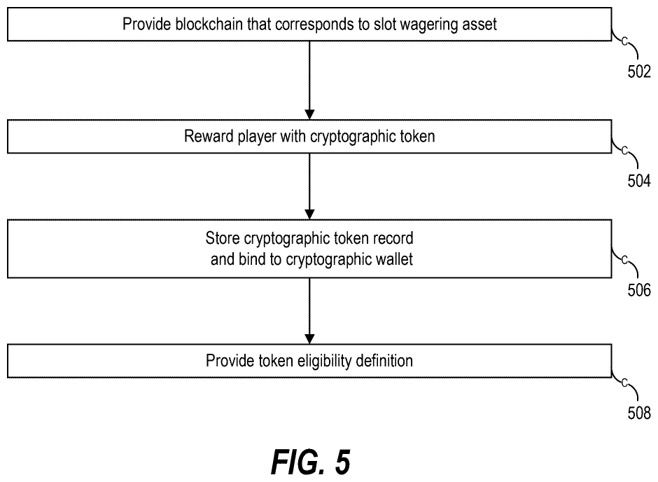

Brief reference is now made to FIG. 5, which is a flowchart illustrating operations of systems/methods for providing wagering game tokenization of a physical wagering asset according to some embodiments. A system according to some embodiments may include a processor circuit and a memory coupled to the processor circuit. The memory may include machine-readable instructions that, when executed by the processor circuit, cause the processor circuit to perform providing (block 502) a blockchain that corresponds with a designated slot wagering asset. Operations include rewarding (block 504) a player of the designated slot wagering asset by providing a cryptographic token that corresponds to the designated slot wagering asset. In some embodiments, the value may be return value to the player based on another player redeeming benefits corresponding to the cryptographic token. Some embodiments include, based on providing the player the cryptographic token that, a token record is caused to be stored (block 506) in the blockchain. Some embodiments provide that the cryptographic token is bound to a player cryptowallet. In some embodiments, the blockchain includes a decentralized and distributed digital ledger that includes blocks and/portions of a data block. In some embodiments, the designated slot wagering asset includes a given electronic gaming machine (EGM) at a given location.

In some embodiments, the EGM includes multiple EGMs that correspond to games that are in a same casino as one another. In some embodiments, the EGM includes multiple EGMs that correspond to EGMs in multiple different casinos. Some embodiments include a token type including a cosmetic modification of a display of the designated slot wagering asset.

In some embodiments, a token type includes a modification to a payout mode. Some embodiments provide that the modification to the payout mode includes a change in trigger probabilities corresponding to a payout. In some embodiments, the modification to the payout mode includes a modification of game rules. Some embodiments provide that the modification to the payout mode includes enabling additions bonus rounds. In some embodiments, the modification to the payout mode includes activating a jackpot level to a higher jackpot level.

In some embodiments, the cryptographic token is tradable during gameplay. In some embodiments, the cryptographic token is exchanged for currency. Some embodiments provide that the cryptographic token is transferred to another player in a transaction between the player and the another player.

In some embodiments, a first cryptographic token is associated with a first brand and a second cryptographic token is associated with a second brand that is different from the first brand. Some embodiments provide that the first cryptographic token is tradable with the second cryptographic token. In some embodiments, the player cryptowallet includes a first player cryptowallet. Some embodiments provide that the first cryptographic token is issued by a first casino and stored in the first player cryptowallet that is associated with the first casino. In some embodiments, the second cryptographic token is issued by a second casino that is different from the first casino and the first cryptographic token is exclusive to the first casino relative to the second casino.

In some embodiments, the processor circuit is further caused to provide a token eligibility definition that identifies a plurality of game play elements that the player completes to become eligible to receive the cryptographic token.

Some embodiments provide that the cryptographic token includes multiple cryptographic tokens that comprise a first cryptographic token providing a graphical change to gameplay, a second cryptographic token providing a first change in bonus trigger chances, and a third cryptographic token providing a second change in bonus trigger chances that is different from the first change in bonus trigger chances.

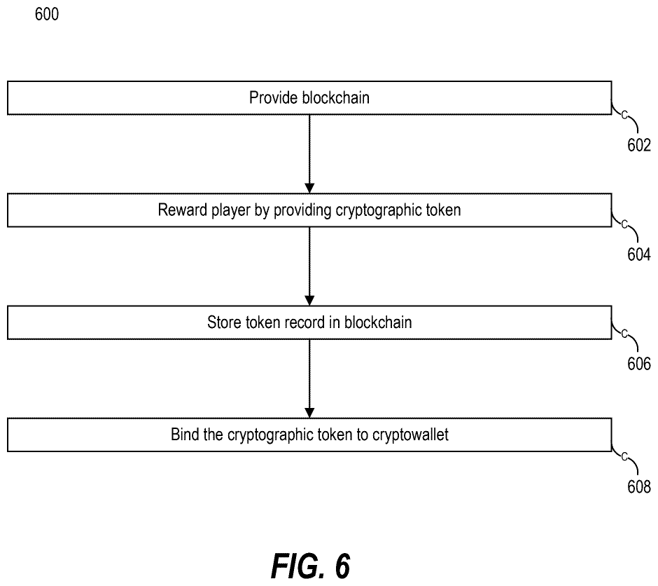

Brief reference is now made to FIG. 6, which is a flowchart illustrating operations of systems/devices/methods for providing wagering game tokenization of a physical wagering asset according to some embodiments. Some embodiments include a gaming device that includes a processor circuit and a memory coupled to the processor circuit. The memory includes machine-readable instructions that, when executed by the processor circuit, cause the processor circuit toper form operation described herein. For example, the processor circuit provides (block 602) a blockchain that corresponds with an electronic gaming machine (EGM) at a given location. The processor circuit is further caused to reward (block 604) a player of the EGM by providing a cryptographic token that corresponds to the EGM, and that returns value to the player based on other players redeeming benefits corresponding to the cryptographic token. Some embodiments provide that the cryptographic token includes a token type that causes a modification in a payout mode that corresponds to a change in trigger probabilities. In some embodiments, the cryptographic token is exchanged for currency during game play. The processor circuit is further caused to store (block 606), based on providing the player the cryptographic token, a token record in the blockchain. The processor circuit is further caused to bind (block 608) the cryptographic token to a player cryptowallet.

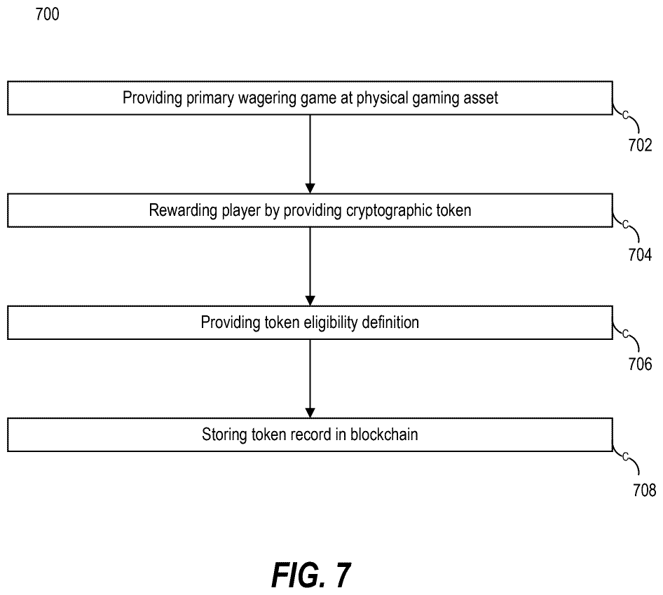

Brief reference is now made to FIG. 7, which is a flowchart illustrating operations of systems/devices/methods for providing wagering game tokenization of a physical wagering asset according to some embodiments. In some embodiments, methods described herein may include operations of providing (block 702), by a processor circuit, a primary wagering game at a physical gaming asset to a player. Operations may include rewarding (block 704) the player of the physical gaming asset by providing a cryptographic token that corresponds to the physical gaming asset and that returns value to the player based on other players redeeming benefits corresponding to the cryptographic token. In some embodiments, the cryptographic token includes a first cryptographic token that is associated with a first brand and a second cryptographic token is associated with a second brand that is different from the first brand. In some embodiments, the first cryptographic token is tradable with the second cryptographic token during game play. Operations may include providing (block 706) a token eligibility definition that identifies a plurality of game play elements that the player completes to become eligible to receive the cryptographic token. Operations include storing (block 708), based on providing the player the cryptographic token, a token record in a blockchain in which the cryptographic token is bound to a player cryptowallet.

Embodiments described herein may be implemented in various configurations for gaming devices 100, including but not limited to: (1) a dedicated gaming device, wherein the computerized instructions for controlling any games (which are provided by the gaming device) are provided with the gaming device prior to delivery to a gaming establishment; and (2) a changeable gaming device, where the computerized instructions for controlling any games (which are provided by the gaming device) are downloadable to the gaming device through a data network when the gaming device is in a gaming establishment. In some embodiments, the computerized instructions for controlling any games are executed by at least one central server, central controller or remote host. In such a “thin client” embodiment, the central server remotely controls any games (or other suitable interfaces), and the gaming device is utilized to display such games (or suitable interfaces) and receive one or more inputs or commands from a player. In another embodiment, the computerized instructions for controlling any games are communicated from the central server, central controller or remote host to a gaming device local processor and memory devices. In such a “thick client” embodiment, the gaming device local processor executes the communicated computerized instructions to control any games (or other suitable interfaces) provided to a player.

In some embodiments, a gaming device may be operated by a mobile device, such as a mobile telephone, tablet other mobile computing device. For example, a mobile device may be communicatively coupled to a gaming device and may include a user interface that receives user inputs that are received to control the gaming device. The user inputs may be received by the gaming device via the mobile device.

In some embodiments, one or more gaming devices in a gaming system may be thin client gaming devices and one or more gaming devices in the gaming system may be thick client gaming devices. In another embodiment, certain functions of the gaming device are implemented in a thin client environment and certain other functions of the gaming device are implemented in a thick client environment. In one such embodiment, computerized instructions for controlling any primary games are communicated from the central server to the gaming device in a thick client configuration and computerized instructions for controlling any secondary games or bonus functions are executed by a central server in a thin client configuration.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more gaming devices; and/or (c) one or more personal gaming devices, such as desktop computers, laptop computers, tablet computers or computing devices, PDAs, mobile telephones such as smart phones, and other mobile computing devices.

In certain such embodiments, computerized instructions for controlling any games (such as any primary or base games and/or any secondary or bonus games) displayed by the gaming device are executed by the central server, central controller, or remote host. In such “thin client” embodiments, the central server, central controller, or remote host remotely controls any games (or other suitable interfaces) displayed by the gaming device, and the gaming device is utilized to display such games (or suitable interfaces) and to receive one or more inputs or commands. In other such embodiments, computerized instructions for controlling any games displayed by the gaming device are communicated from the central server, central controller, or remote host to the gaming device and are stored in at least one memory device of the gaming device. In such “thick client” embodiments, the at least one processor of the gaming device executes the computerized instructions to control any games (or other suitable interfaces) displayed by the gaming device.

In some embodiments in which the gaming system includes: (a) a gaming device configured to communicate with a central server, central controller, or remote host through a data network; and/or (b) a plurality of gaming devices configured to communicate with one another through a data network, the data network is an internet or an intranet. In certain such embodiments, an internet browser of the gaming device is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the gaming device, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games and displays those plays via the internet browser of the gaming device.

It should be appreciated that the central server, central controller, or remote host and the gaming device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of gaming devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In the above description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product including one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (“RF”), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, Common Business Oriented Language (“COBOL”) 2002, PHP: Hypertext Processor (“PHP”), Advanced Business Application Programming (“ABAP”), dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processing circuit of a general purpose computer, special purpose computer, or other programmable data processing apparatus to produce a machine, such that the instructions, which execute via the processing circuit of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operations to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A system comprising:
a processor circuit; and
a memory coupled to the processor circuit, the memory comprising machine-readable instructions that, when executed by the processor circuit, cause the processor circuit to:
provide a blockchain that corresponds with a designated slot wagering asset;
reward a player of the designated slot wagering asset by providing a cryptographic token that corresponds to the designated slot wagering asset, and that returns value to the player based on another player redeeming benefits corresponding to the cryptographic token; and
based on providing the player the cryptographic token, a token record is caused to be stored in the blockchain and the cryptographic token is bound to a player cryptowallet.

2. The system of claim 1, wherein the blockchain comprises a decentralized and distributed digital ledger that comprises portions of a data block.

3. The system of claim 1, wherein the designated slot wagering asset comprises a given electronic gaming machine (EGM) at a given location.

4. The system of claim 3, wherein the EGM comprises a plurality of EGMs that correspond to games that are in a same casino as one another.

5. The system of claim 3, wherein the EGM comprises a plurality of EGMs that correspond to EGMs in a plurality of different casinos.

6. The system of claim 1, wherein a token type comprises a cosmetic modification of a display of the designated slot wagering asset.

7. The system of claim 1, wherein a token type comprises a modification to a payout mode.

8. The system of claim 7, wherein the modification to the payout mode comprises a change in trigger probabilities corresponding to a payout.

9. The system of claim 7, wherein the modification to the payout mode comprises a modification of game rules.

10. The system of claim 7, wherein the modification to the payout mode comprises enabling additions bonus rounds.

11. The system of claim 7, wherein the modification to the payout mode comprises activating a jackpot level to a higher jackpot level.

12. The system of claim 1, wherein the cryptographic token is tradable during gameplay.

13. The system of claim 12, wherein the cryptographic token is exchanged for currency.

14. The system of claim 12, wherein the cryptographic token is transferred to another player in a transaction between the player and the another player.

15. The system of claim 1, wherein a first cryptographic token is associated with a first brand and a second cryptographic token is associated with a second brand that is different from the first brand,
wherein the first cryptographic token is tradable with the second cryptographic token.

16. The system of claim 15, wherein the player cryptowallet comprises a first player cryptowallet,
wherein the first cryptographic token is issued by a first casino and stored in the first player cryptowallet that is associated with the first casino,
wherein the second cryptographic token is issued by a second casino that is different from the first casino, and
wherein the first cryptographic token is exclusive to the first casino relative to the second casino.

17. The system of claim 1, wherein the processor circuit is further caused to provide a token eligibility definition that identifies a plurality of game play elements that the player completes to become eligible to receive the cryptographic token.

18. The system of claim 1, wherein the cryptographic token comprises a plurality of cryptographic tokens that comprises:
a first cryptographic token providing a graphical change to gameplay, a second cryptographic token providing a first change in bonus trigger chances, and a third cryptographic token providing a second change in bonus trigger chances that is different from the first change in bonus trigger chances.

19. A gaming device comprising:
a processor circuit; and
a memory coupled to the processor circuit, the memory comprising machine-readable instructions that, when executed by the processor circuit, cause the processor circuit to:
provide a blockchain that corresponds with an electronic gaming machine (EGM) at a given location;
reward a player of the EGM by providing a cryptographic token that corresponds to the EGM, and that returns value to the player based on other players redeeming benefits corresponding to the cryptographic token, wherein the cryptographic token comprises a token type that causes a modification in a payout mode that corresponds to a change in trigger probabilities, and wherein the cryptographic token is exchanged for currency during game play;
store, based on providing the player the cryptographic token, a token record in the blockchain; and
bind the cryptographic token to a player cryptowallet.

20. A method comprising:
providing, by a processor circuit, a primary wagering game at a physical gaming asset to a player;
rewarding the player of the physical gaming asset by providing a cryptographic token that corresponds to the physical gaming asset and that returns value to the player based on other players redeeming benefits corresponding to the cryptographic token, wherein the cryptographic token comprises a first cryptographic token that is associated with a first brand and a second cryptographic token is associated with a second brand that is different from the first brand, wherein the first cryptographic token is tradable with the second cryptographic token during game play;
providing a token eligibility definition that identifies a plurality of game play elements that the player completes to become eligible to receive the cryptographic token; and
storing, based on providing the player the cryptographic token, a token record in a blockchain in which the cryptographic token is bound to a player cryptowallet.
